(19) United States
(12) Patent Application Publication
(10) Pub. No.: US 2026/0141711 A1
(43) Pub. Date: May 21, 2026

(54) ARTIFICIAL INTELLIGENCE CAMERA AND OPERATING METHOD OF ARTIFICIAL INTELLIGENCE CAMERA

(71) Applicant: ELECTRONICS AND TELECOMMUNICATIONS RESEARCH INSTITUTE, Daejeon (KR)

(72) Inventors: Suntak PARK, Daejeon (KR); Jong Moo SOHN, Daejeon (KR); Jung-Ho SONG, Daejeon (KR); Hyung Cheol SHIN, Daejeon (KR); Jin Hwa GENE, Daejeon (KR); Seung Koo PARK, Daejeon (KR); Eun Jin SHIN, Daejeon (KR)

(21) Appl. No.: 19/392,477

(22) Filed: Nov. 18, 2025

(30) Foreign Application Priority Data
Nov. 21, 2024 (KR) 10-2024-0167193
Mar. 28, 2025 (KR) 10-2025-0040465

(51) Int. Cl. G06V 10/88; G02B 27/42; G06V 10/14; G06V 10/82; H04N 25/40; H04N 25/703

(52) U.S. Cl. CPC G06V 10/88; G02B 27/4233; G06V 10/14; G06V 10/82; H04N 25/40; H04N 25/703

(57) ABSTRACT

An artificial intelligence (AI) camera includes a lens, an AI optical system that generates a processed light by performing a neural network operation based on first input light incident through the lens, and an image sensor that generates image data based on the processed light and identifies an image pattern based on the image data.

### CROSS-REFERENCE TO RELATED APPLICATIONS

This application claims priority under 35 U.S.C. § 119 to Korean Patent Application No. 10-2024-0167193 filed on Nov. 21, 2024 and No. 10-2025-0040465 filed on Mar. 28, 2025, in the Korean Intellectual Property Office, the disclosures of which are incorporated by reference herein in their entireties.

### BACKGROUND

Embodiments of the present disclosure described herein relate to an artificial intelligence (AI) camera, and more particularly, relate to an AI camera that identifies patterns or images in real time by using an AI optical system based on an optical technology, and an operating method of the artificial intelligence camera.

An AI technology is a technology that artificially implements human learning, reasoning, and perception abilities by using computers, and is being applied in many fields. In particular, the AI technology is showing excellent performance in the field of image processing based on the technology of processing large amounts of data.

In the meantime, with the advancement of technology, cameras may obtain high-resolution images or videos, and are expected to expand to more applications in the future.

Nowadays, camera systems that incorporate the AI technology are being developed. These camera systems may analyze and determine the large amount of obtained data by using AI, thereby quickly recognizing special situations such as falls, water leaks, and dangerous situations.

A camera system with embedded AI technology consists of a camera and an AI system that analyzes images obtained by the camera. The AI system is implemented as a separate hardware such as a computer or chip depending on application fields. Accordingly, the volume of the camera system increases; a lot of energy is consumed in the process of calculating large amounts of data; and a time delay occurs due to image recognition and discrimination.

To overcome the above-mentioned issues, a single system is required to perform image acquisition and image analysis.

### SUMMARY

Embodiments of the present disclosure provide an AI camera that identifies patterns or images in real time by using an AI optical system based on an optical technology, and an operating method of the artificial intelligence camera.

According to an embodiment, an artificial intelligence (AI) camera includes a lens, an AI optical system that generates a processed light by performing a neural network operation based on first input light incident through the lens, and an image sensor that generates image data based on the processed light and identifies an image pattern based on the image data.

For example, the AI camera further includes a coherent optical converter that outputs a converted light based on the first input light. The first input light is incoherent light and the converted light is coherent light.

For example, the coherent optical converter includes a light source that outputs second input light, a smart pixel array that generates the converted light based on the first input light and the second input light, and a beam splitter that outputs the first input light and the second input light to the smart pixel array.

For example, the smart pixel array includes a plurality of smart pixels. Each of the plurality of smart pixels includes a first semiconductor element and a second semiconductor element. The first semiconductor element receives the first input light and generates an electrical signal based on the received first input light. The second semiconductor element receives the second input light and controls transmittance or reflectivity of the received second input light based on the electrical signal.

For example, the AI optical system is based on a diffractive optical neural network.

For example, the AI optical system includes at least one diffractive optical element including a plurality of pixels.

For example, the at least one diffractive optical element adjusts at least one of intensity and a phase of light.

For example, the at least one diffractive optical element adjusts the intensity, and each of the plurality of pixels has different transmittance of light.

For example, the at least one diffractive optical element adjusts the phase, and each of the plurality of pixels has a different phase modulation value.

For example, the AI optical system is based on an optical convolutional artificial neural network using a 4F optical system.

For example, the 4F optical system includes a filter including a plurality of pixels, and a filter value of each of the plurality of pixels is determined by using an AI algorithm so as to modulate intensity or a phase of light.

According to an embodiment, a method of operating an AI camera includes receiving first input light reflected from an object through a lens, generating, by an AI optical system, a processed light by performing a neural network operation based on the first input light, generating, by an image sensor, image data based on the processed light, and identifying, by the image sensor, an image pattern based on the image data.

For example, the receiving of the first input light reflected from the object through the lens includes outputting, by a coherent optical converter, a converted light based on the first input light. The first input light is incoherent light and the converted light is coherent light.

For example, the outputting, by the coherent optical converter, of the converted light based on the first input light includes outputting, by a light source, second input light, and generating, by a smart pixel array, the converted light based on the first input light and the second input light.

For example, the smart pixel array includes a smart pixel including a first semiconductor element and a second semiconductor element. The generating, by the smart pixel array, of the converted light based on the first input light and the second input light includes generating, by the first semiconductor element, an electrical signal based on the first input light, and controlling, by the second semiconductor element, transmittance or reflectivity of the second input light based on the electrical signal.

For example, the AI optical system is based on a diffractive optical neural network.

For example, the AI optical system includes at least one diffractive optical element including a plurality of pixels.

For example, the at least one diffractive optical element adjusts intensity of light, and each of the plurality of pixels has different transmittance of light.

For example, the at least one diffractive optical element adjusts a phase of light, and each of the plurality of pixels has a different phase modulation value.

For example, the AI optical system is based on an optical convolutional artificial neural network using a 4F optical system.

### BRIEF DESCRIPTION OF THE FIGURES

The above and other objects and features of the present disclosure will become apparent by describing in detail embodiments thereof with reference to the accompanying drawings.

FIG. 1 shows an example of an AI-based camera system.

FIG. 2 shows an example of an AI camera, according to an embodiment of the present disclosure.

FIG. 3 illustrates a specific example of the AI camera of FIG. 2.

FIG. 4 shows an example of an amplitude diffractive optical element, according to an embodiment of the present disclosure.

FIG. 5 shows an example of an AI camera, according to an embodiment of the present disclosure.

FIG. 6 shows a specific example of the coherent light converter of FIG. 5.

FIG. 7 shows a specific example of the smart pixel array of FIG. 6.

FIG. 8 illustrates a specific example of the first smart pixel of FIG. 7.

FIG. 9 shows a specific example of the AI camera of FIG. 5.

FIG. 10 illustrates a specific example of the AI camera of FIG. 5.

### DETAILED DESCRIPTION

Hereinafter, embodiments of the present disclosure will be described in detail and clearly to such an extent that an ordinary one in the art easily implements the present disclosure.

Hereinafter, embodiments of the present disclosure will be described in detail with reference to the accompanying drawings. The above and other aspects, features and advantages of the present disclosure will become apparent from embodiments to be described in detail in conjunction with the accompanying drawings. However, that the present disclosure is not limited to the following embodiments and may be implemented with various forms. Rather, embodiments introduced herein are provided to ensure that disclosed content is thorough and complete and to sufficiently convey the spirit of the present disclosure to those skilled in the art, and the present disclosure is defined only by the scope of claims. The same reference numerals denote the same elements throughout the specification.

The terms used in the specification are provided to describe the embodiments, not to limit the present disclosure. In the specification, the singular forms include plural forms unless particularly mentioned. The words ‘comprises’ and/or ‘comprising’ as used in the specification do not exclude the presence or addition of one or more other components, operations and/or elements in addition to the mentioned components, operations and/or elements. Moreover, because it is according to a preferred embodiment, the reference signs presented in the order of the description are not necessarily limited to that order.

Furthermore, embodiments described herein will be described with reference to cross-sectional and/or perspective views, which are ideal illustrations of the present disclosure. In the drawings, the thicknesses of films and regions are exaggerated to describe the technical features effectively. As such, variations from the shapes of the illustrations as a result, for example, of manufacturing techniques and/or tolerances, are to be expected. Thus, embodiments of the present disclosure are not limited to the specific shapes shown, but also include variations in shape produced by the manufacturing process.

In the detailed description, components described with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

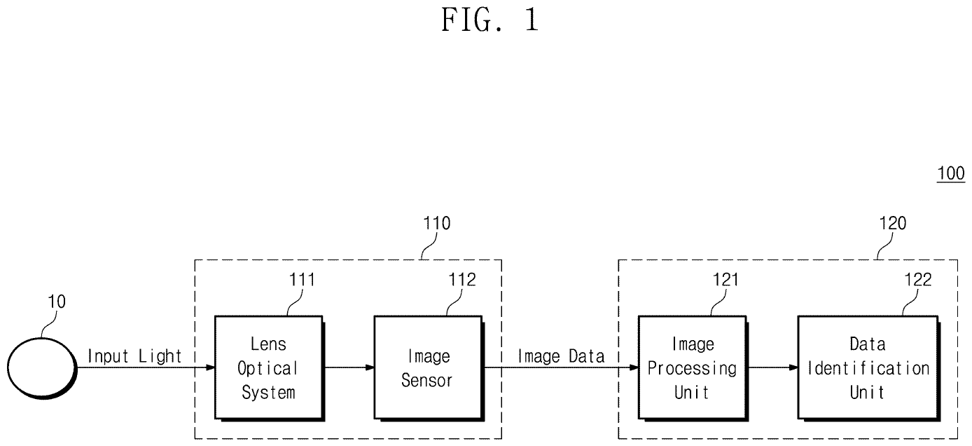

FIG. 1 shows an example of an AI-based camera system.

Referring to FIG. 1, a camera system 100 may include a camera 110 and a data processing unit 120.

The camera 110 may include a lens optical system 111 and an image sensor 112. The lens optical system 111 may receive input light reflected from an object 10 (or the outside). The lens optical system 111 may deliver input light to the image sensor 112.

The image sensor 112 may generate image data based on the input light incident through the lens optical system 111. For example, the image sensor 112 may convert the input light incident through the lens optical system 111 into an electrical signal. The image sensor 112 may generate image data, which is digital data, based on the electrical signal. The image sensor 112 may output the image data.

The data processing unit 120 may include an image processing unit 121 and a data identification unit 122. The image processing unit 121 may receive image data from the image sensor 112. The image processing unit 121 may process the image data based on an AI technology. For example, the image processing unit 121 may analyze the image data for a specific purpose based on the AI technology.

The data identification unit 122 may receive the analyzed image data from the image processing unit 121. The data identification unit 122 may identify the analyzed image data based on the AI technology. For example, the data identification unit 122 may identify an image pattern or an image from the analyzed image data based on the AI technology.

In FIG. 1, the data processing unit 120 may be implemented as a separate chip or computing device (e.g., a computer). As a result, the volume of the camera system 100 increases; a lot of energy is consumed in the process of processing large amounts of data; and, time delay occurs due to image recognition and discrimination.

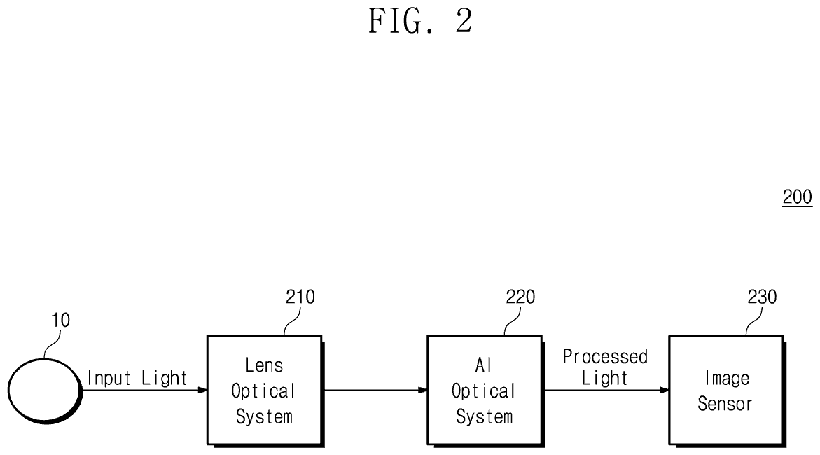

FIG. 2 shows an example of an AI camera, according to an embodiment of the present disclosure.

Referring to FIG. 2, an AI camera 200 may include a lens optical system 210, an AI optical system 220, and an image sensor 230.

The lens optical system 210 may receive input light reflected from the object 10 (or the outside). The lens optical system 210 may deliver the input light to the AI optical system 220. In an embodiment, the lens optical system 210 is movable. As the location of the lens optical system 210 changes according to the movement of the lens optical system 210, the focal length of the lens optical system 210 may change.

The AI optical system 220 may perform neural network operations based on the input light incident through the lens optical system 210. For example, the AI optical system 220 may perform neural network operations to process and analyze the input light or an optical image formed by the input light. As a result of performing the neural network operations, the AI optical system 220 may generate a processed light and may output the processed light thus generated to the image sensor 230.

In an embodiment, the AI optical system 220 may be implemented based on a diffractive optical neural network or an optical convolutional artificial neural network. However, the scope of the present disclosure is not limited thereto and may be implemented based on various optical neural networks.

The image sensor 230 may identify an image pattern or an image based on the processed light. For example, the image sensor 230 may receive the processed light from the AI optical system 220. The image sensor 230 may generate image data, which is digital data, based on the processed light. The image sensor 230 may identify an image pattern or an image from the image data.

In FIG. 2, the AI camera 200 may implement an AI technology by using an optical method, thereby reducing power consumption and performing neural network operations at the speed of light.

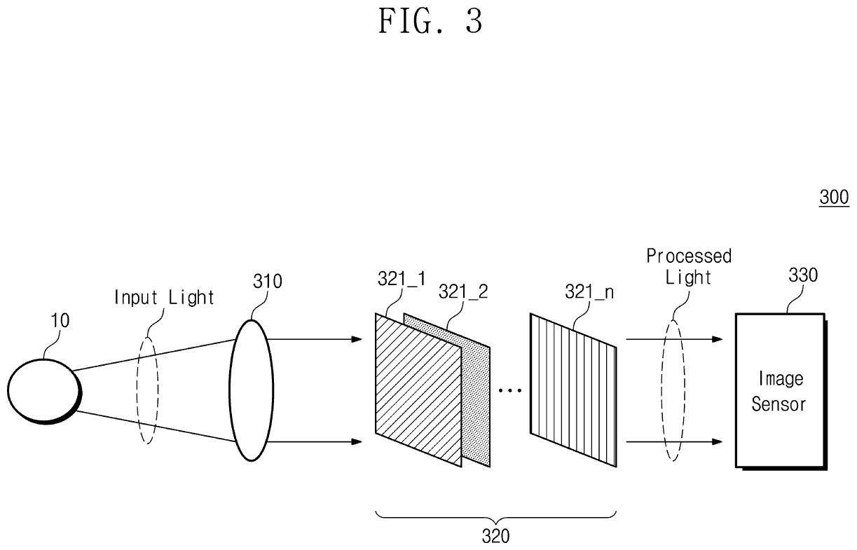

FIG. 3 illustrates a specific example of the AI camera of FIG. 2. In FIG. 3, an AI camera 300 may perform neural network operations based on a diffractive optical neural network.

Referring to FIGS. 2 and 3, the AI camera 300 may include an lens 310, an AI optical system 320, and an image sensor 330. In FIG. 3, the lens 310 may correspond to the lens optical system 210 of FIG. 2; the AI optical system 320 may correspond to the AI optical system 220 of FIG. 2; and the image sensor 330 may correspond to the image sensor 230 of FIG. 2. Accordingly, for convenience of description, redundant descriptions are omitted.

The AI optical system 320 may include a plurality of amplitude diffractive optical elements 321_1 to 321_n. Each of the plurality of amplitude diffractive optical elements 321_1 to 321_n may perform a neural network operation. For example, each of the plurality of amplitude diffractive optical elements 321_1 to 321_n may perform a neural network operation based on the diffraction and interference of light. The neural network operation may include a linear operation and a nonlinear operation. As a result of performing the neural network operations, the AI optical system 320 may generate the processed light and may deliver the processed light thus generated to the image sensor 330.

In an embodiment, the linear operation may be performed based on the diffraction of light.

In an embodiment, after the linear operation is performed, the nonlinear operation may be performed based on the interference of light. For example, an activation function operation may be performed based on the interference of light. Light on which the nonlinear operation is performed may have a specific pattern (e.g., a specific optical pattern).

In FIG. 3, the AI optical system 320 is illustrated as including the plurality of amplitude diffractive optical elements 321_1 to 321_n, but the AI optical system 320 may include one amplitude diffractive optical element. That is, the AI optical system 320 may include at least one amplitude diffractive optical element.

In an embodiment, as the number of amplitude diffractive optical elements increases, the identification accuracy of the image pattern of the AI camera 300 may be improved.

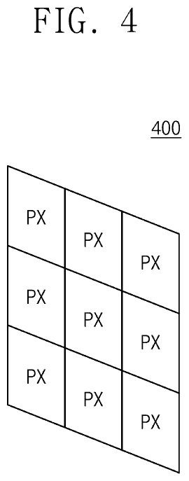

FIG. 4 shows an example of an amplitude diffractive optical element, according to an embodiment of the present disclosure.

Referring to FIG. 4, an amplitude diffractive optical element 400 may include a plurality of pixels PX. At least some of the plurality of pixels PX may have different light transmittances (or reflectivity). That is, when light of the same intensity is incident on the plurality of pixels PX, the intensity of the transmitted light may vary for each pixel PX. For example, at least some of the plurality of pixels PX may have different light transmittances, while the others thereof may have the same light transmittance. Alternatively, the plurality of pixels PX may have different light transmittances, respectively.

In an embodiment, the light transmittance of at least some of the plurality of pixels PX may be 0%. That is, at least some of the plurality of pixels PX may completely block light.

In an embodiment, the light transmittance of at least some of the plurality of pixels PX may be 100 %. That is, at least some of the plurality of pixels PX may completely transmit light.

In an embodiment, the light transmittance of each of the plurality of pixels PX may be determined based on an AI algorithm. For example, the light transmittance of each of the plurality of pixels PX may be determined in advance according to purposes.

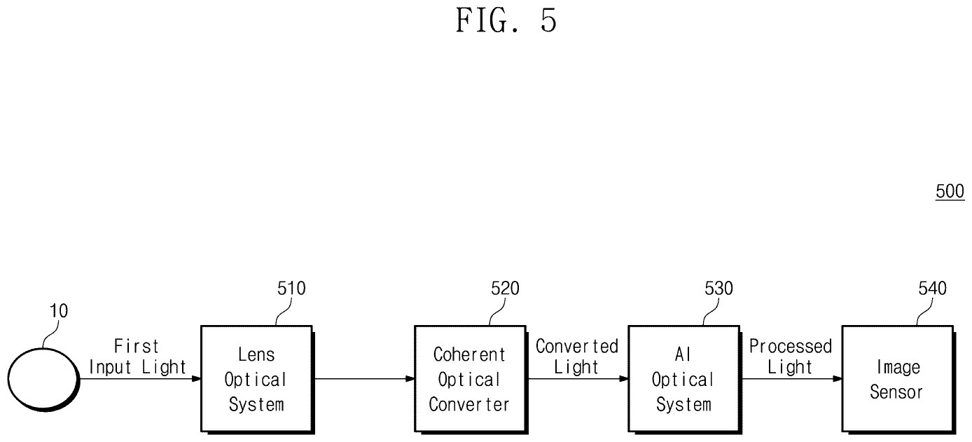

FIG. 5 shows an example of an AI camera, according to an embodiment of the present disclosure.

Referring to FIG. 5, an AI camera 500 may include a lens optical system 510, a coherent optical converter 520, an AI optical system 530, and an image sensor 540. In FIG. 5, the lens optical system 510 may correspond to the lens optical system 210 of FIG. 2; the AI optical system 530 may correspond to the AI optical system 220 of FIG. 2; and the image sensor 540 may correspond to the image sensor 230 of FIG. 2. Accordingly, for convenience of description, redundant descriptions are omitted.

The coherent optical converter 520 may convert light that does not have coherence (hereinafter referred to as ‘incoherent light’) into light that has coherence (hereinafter referred to as ‘coherent light’). For example, the coherent optical converter 520 may receive first input light incident through the lens optical system 510. The first input light may be incoherent light. The coherent optical converter 520 may output a converted light by converting the first input light into coherent light.

The AI optical system 530 may perform a neural network operation based on the converted light output from the coherent optical converter 520.

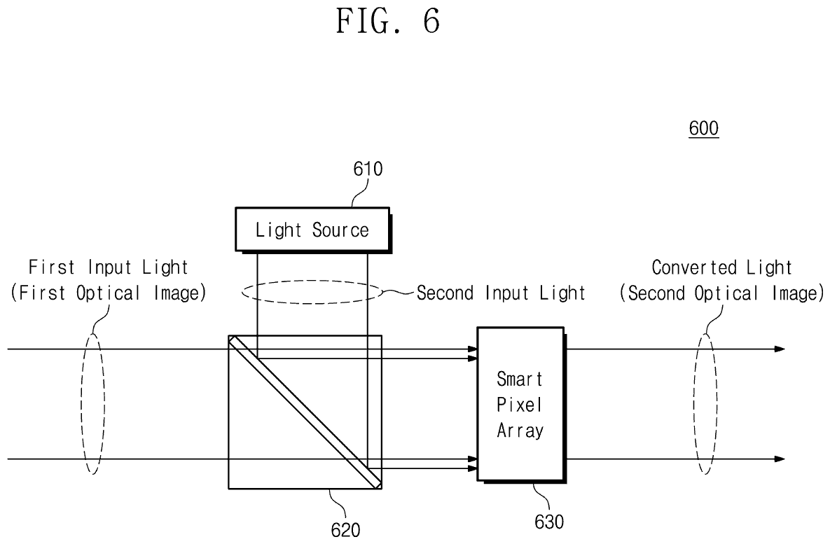

FIG. 6 shows a specific example of the coherent light converter of FIG. 5.

Referring to FIGS. 5 and 6, a coherent optical converter 600 may include a light source 610, a beam splitter 620, and a smart pixel array 630.

The light source 610 may output second input light, which is seed light, to the beam splitter 620. The seed light may represent light used to convert incoherent light into coherent light. In an embodiment, the seed light may be a perfectly coherent light (hereinafter referred to as ‘fully-coherent light’).

In an embodiment, the light source 610 may be a laser.

The beam splitter 620 may receive first input light, which is incoherent light, through the lens optical system 510, and may receive the second input light from the light source 610. In an embodiment, the first input light may form a first optical image. In this case, the first optical image may be an incoherent image.

The beam splitter 620 may reflect or transmit light. For example, the beam splitter 620 may transmit at least part of the first input light. The transmitted first input light may propagate toward the smart pixel array 630.

For example, the beam splitter 620 may reflect at least part of the second input light. As a result of the reflection, the beam splitter 620 may change the path of the second input light. The reflected second input light may propagate toward the smart pixel array 630.

The smart pixel array 630 may receive the first input light and the second input light from the beam splitter 620. The smart pixel array 630 may output a converted light, which is coherent light, based on the first input light and the second input light. In an embodiment, the converted light may form a second optical image. In this case, the second optical image may be a coherent image.

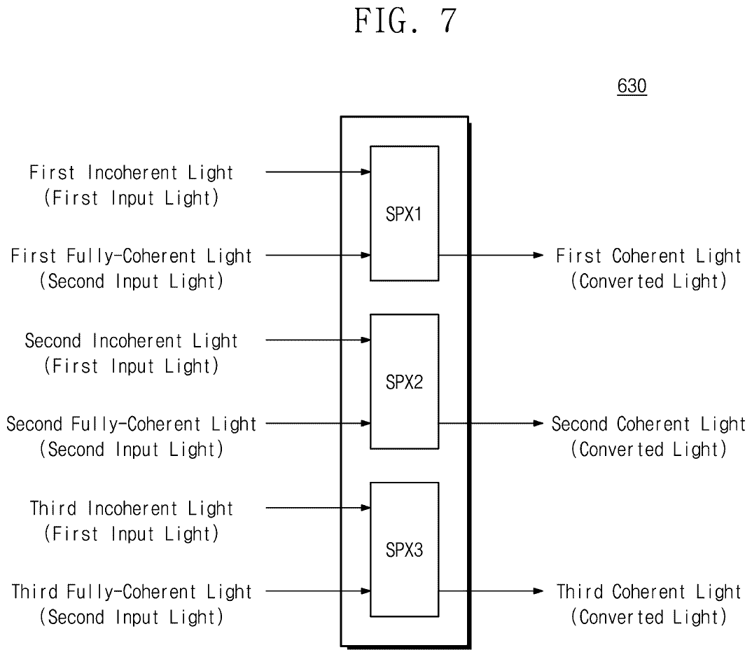

FIG. 7 shows a specific example of the smart pixel array of FIG. 6. In FIG. 7, it is assumed that first incoherent light, second incoherent light, and third incoherent light are included in the first input light of FIG. 6. It is assumed that first fully-coherent light, second fully-coherent light, and third fully-coherent light are included in the second input light of FIG. 6. Moreover, it is assumed that first coherent light, second coherent light, and third coherent light are included in the converted light of FIG. 6.

Referring to FIGS. 6 and 7, the smart pixel array 630 may include first to third smart pixels SPX1 to SPX3. Each of the first to third smart pixels SPX1 to SPX3 may convert incoherent light into coherent light.

For example, the first smart pixel SPX1 may generate first coherent light based on the first incoherent light and the first fully-coherent light. The second smart pixel SPX2 may generate second coherent light based on the second incoherent light and the second fully-coherent light. The third smart pixel SPX3 may generate third coherent light based on the third incoherent light and the third fully-coherent light.

In an embodiment, the wavelengths of the first incoherent light, the second incoherent light, and the third incoherent light may be different from each other. Furthermore, the wavelengths of the first coherent light, the second coherent light, and the third coherent light may be different from each other.

In an embodiment, each of the first to third smart pixels SPX1 to SPX3 may control the intensity of light transmitted or reflected.

FIG. 7 illustrates that the smart pixel array 630 includes the first to third smart pixels SPX1 to SPX3. However, the scope of the present disclosure is not limited thereto. The smart pixel array 630 may include a plurality of smart pixels.

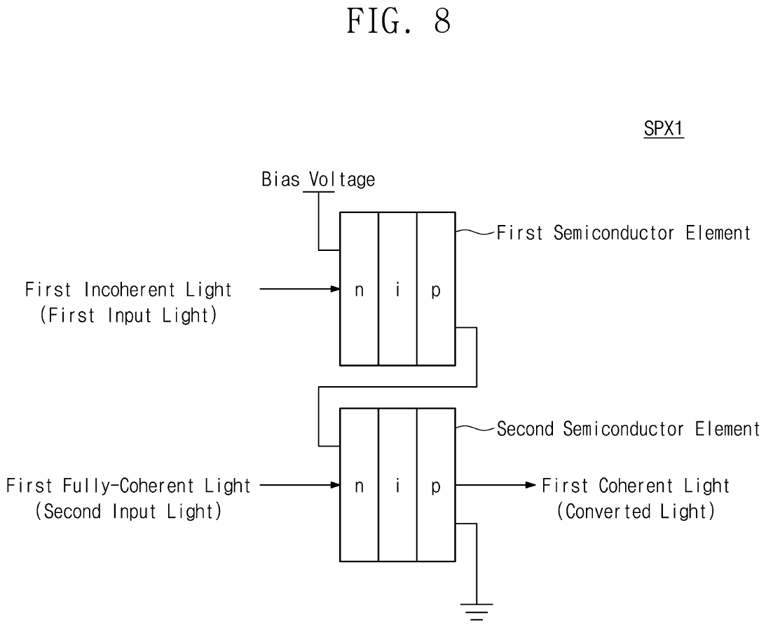

FIG. 8 illustrates a specific example of the first smart pixel of FIG. 7.

Referring to FIGS. 6 to 8, the first smart pixel SPX1 may include a first semiconductor element and a second semiconductor element. Each of the first semiconductor element and the second semiconductor element may include an N-type semiconductor layer, an intrinsic semiconductor layer, and a P-type semiconductor layer.

A bias voltage may be applied to the N-type semiconductor layer of the first semiconductor element, and the P-type semiconductor layer of the first semiconductor element may be electrically connected to the N-type semiconductor layer of the second semiconductor element. A ground voltage may be applied to the P-type semiconductor layer of the second semiconductor element.

The first semiconductor element may receive first incoherent light. The first semiconductor element may generate an electrical signal based on the first incoherent light. The generated electrical signal may be delivered from the P-type semiconductor layer of the first semiconductor element to the N-type semiconductor layer of the second semiconductor element.

The second semiconductor element may control the transmittance or reflectivity of the first fully-coherent light based on the electrical signal delivered from the first semiconductor element. As the result of controlling the transmittance or reflectivity of the first fully-coherent light, the intensity of the first coherent light may be adjusted.

In an embodiment, the wavelengths of the first incoherent light and the first fully-coherent light may be different from or the same as each other.

In FIG. 8, the first smart pixel SPX1 is described as an example, but each of the remaining smart pixels SPX2 and SPX3 included in the smart pixel array 630 operates identically or similarly to the first smart pixel SPX1.

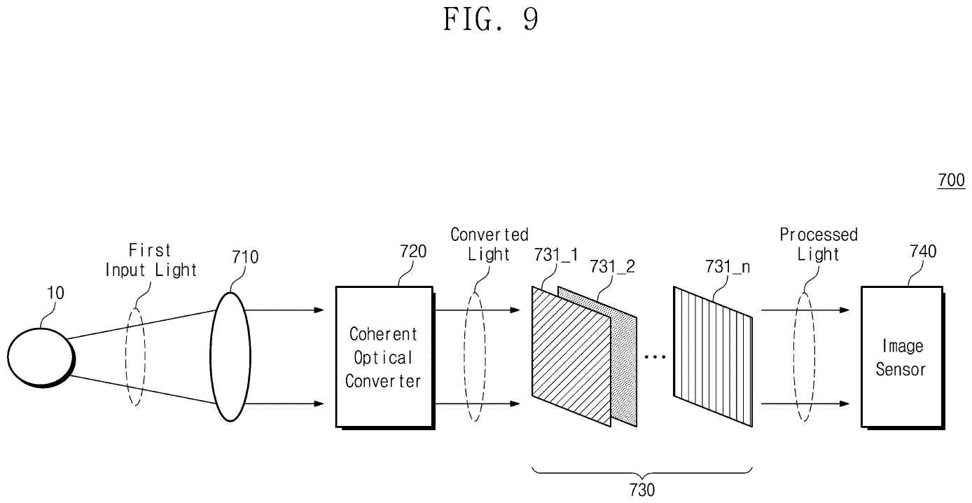

FIG. 9 shows a specific example of the AI camera of FIG. 5. In FIG. 9, an AI camera 700 may perform neural network operations based on a diffractive optical neural network.

Referring to FIGS. 5 to 9, the AI camera 700 may include a lens 710, a coherent optical converter 720, an AI optical system 730, and an image sensor 740. In FIG. 9, the lens 710 may correspond to the lens optical system 510 of FIG. 5; the coherent optical converter 720 may correspond to the coherent optical converter 520 of FIG. 5; the AI optical system 730 may correspond to the AI optical system 530 of FIG. 5; and the image sensor 740 may correspond to the image sensor 540 of FIG. 5. Accordingly, for convenience of description, redundant descriptions are omitted.

The AI optical system 730 may include a plurality of phase diffractive optical elements 731_1 to 731_n. Each of the plurality of phase diffractive optical elements 731_1 to 731_n may perform a neural network operation. For example, each of the plurality of phase diffractive optical elements 731_1 to 731_n may perform neural network operations based on diffraction, phase modulation, and interference of light. As a result of performing the neural network operations, the AI optical system 730 may generate the processed light and may deliver the processed light thus generated to the image sensor 740.

In an embodiment, linear operations may be performed based on light diffraction and phase modulation. In this case, a weighting operation of the linear operation may be performed based on a preset phase modulation value (e.g., a trained phase modulation value).

Each of the plurality of phase diffractive optical elements 731_1 to 731_n may include a plurality of pixels. In each of the plurality of phase diffractive optical elements 731_1 to 731_n, at least some of a plurality of pixels may have different phase modulation values. That is, when light having the same phase is incident on the plurality of pixels, the phase of the transmitted light may vary for each pixel. For example, at least some of the plurality of pixels may have different phase modulation values, and the others thereof may have the same phase modulation value. Alternatively, each of the plurality of pixels may have different phase modulation values from each other.

In an embodiment, the phase modulation value of each of the plurality of pixels may be determined based on an AI algorithm. For example, the phase modulation values of each of a plurality of pixels may be predetermined according to purposes.

In an embodiment, the AI optical system 730 may train weights and may continuously adjust values of the weights based on the neural network operations of the plurality of phase diffractive optical elements 731_1 to 731_n.

In FIG. 9, the AI optical system 730 is illustrated as including the plurality of phase diffractive optical elements 731_1 to 731_n, but the AI optical system 730 may include one phase diffractive optical element. That is, the AI optical system 730 may include at least one phase diffractive optical element.

In an embodiment, the AI optical system 730 may include a plurality of diffractive optical elements that simultaneously modulate the intensity and phase of light instead of the plurality of phase diffractive optical elements 731_1 to 731_n.

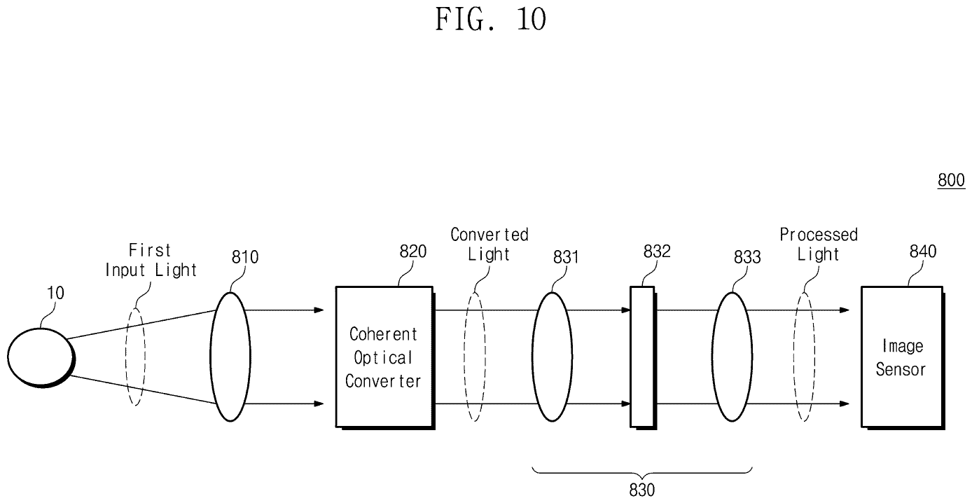

FIG. 10 illustrates a specific example of the AI camera of FIG. 5. In FIG. 10, an AI camera 800 may perform a neural network operation based on an optical convolutional artificial neural network.

Referring to FIGS. 5 to 8 and 10, the AI camera 800 may include a lens 810, a coherent optical converter 820, an AI optical system 830, and an image sensor 840. In FIG. 10, the lens 810 may correspond to the lens optical system 510 of FIG. 5; the coherent optical converter 820 may correspond to the coherent optical converter 520 of FIG. 5; the AI optical system 830 may correspond to the AI optical system 530 of FIG. 5; and the image sensor 840 may correspond to the image sensor 540 of FIG. 5. Accordingly, for convenience of description, redundant descriptions are omitted.

The AI optical system 830 may be implemented based on a 4F optical system. The AI optical system 830 may include a first lens 831, a filter 832, and a second lens 832.

The filter 832 may include a plurality of pixels. The filter value of each of the plurality of pixels may be determined by using an AI algorithm so as to modulate the intensity or phase of light. When the filter 832 modulates the intensity of light, the coherent optical converter 720 may be omitted.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

The above-mentioned description refers to embodiments for implementing the scope of the present disclosure. Embodiments in which a design is changed simply or which are easily changed may be included in the scope of the present disclosure as well as an embodiment described above. In addition, technologies that are easily changed and implemented by using the above-mentioned embodiments may be also included in the scope of the present disclosure.

An AI camera according to an embodiment of the present disclosure may reduce the volume of the entire system, by utilizing an AI optical system instead of separate hardware for applying an AI technology.

The AI camera according to an embodiment of the present disclosure processes data by using an optical system, thereby reducing power consumption and eliminating latency. Accordingly, the AI camera may recognize and discriminate image patterns or images in real time.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An artificial intelligence (AI) camera comprising:
a lens;
an AI optical system configured to generate a processed light by performing a neural network operation based on first input light incident through the lens; and
an image sensor configured to generate image data based on the processed light and to identify an image pattern based on the image data.

2. The AI camera of claim 1, further comprising:
a coherent optical converter configured to output a converted light based on the first input light,
wherein the first input light is incoherent light and the converted light is coherent light.

3. The AI camera of claim 2, wherein the coherent optical converter includes:
a light source configured to output second input light;
a smart pixel array configured to generate the converted light based on the first input light and the second input light; and
a beam splitter configured to output the first input light and the second input light to the smart pixel array.

4. The AI camera of claim 3, wherein the smart pixel array includes a plurality of smart pixels,
wherein each of the plurality of smart pixels includes a first semiconductor element and a second semiconductor element,
wherein the first semiconductor element receives the first input light and generates an electrical signal based on the received first input light, and
wherein the second semiconductor element receives the second input light and controls transmittance or reflectivity of the received second input light based on the electrical signal.

5. The AI camera of claim 4, wherein the AI optical system is based on a diffractive optical neural network.

6. The AI camera of claim 5, wherein the AI optical system includes at least one diffractive optical element including a plurality of pixels.

7. The AI camera of claim 6, wherein the at least one diffractive optical element adjusts at least one of intensity and a phase of light.

8. The AI camera of claim 7, wherein the at least one diffractive optical element adjusts the intensity, and
wherein each of the plurality of pixels has different transmittance of light.

9. The AI camera of claim 7, wherein the at least one diffractive optical element adjusts the phase, and
wherein each of the plurality of pixels has a different phase modulation value.

10. The AI camera of claim 4, wherein the AI optical system is based on an optical convolutional artificial neural network using a 4F optical system.

11. The AI camera of claim 10, wherein the 4F optical system includes a filter including a plurality of pixels, and
wherein a filter value of each of the plurality of pixels is determined by using an AI algorithm so as to modulate intensity or a phase of light.

12. A method of operating an AI camera, the method comprising:
receiving first input light reflected from an object through a lens;
generating, by an AI optical system, a processed light by performing a neural network operation based on the first input light;
generating, by an image sensor, image data based on the processed light; and
identifying, by the image sensor, an image pattern based on the image data.

13. The method of claim 12, wherein the receiving of the first input light reflected from the object through the lens includes:
outputting, by a coherent optical converter, a converted light based on the first input light, and
wherein the first input light is incoherent light and the converted light is coherent light.

14. The method of claim 13, wherein the outputting, by the coherent optical converter, of the converted light based on the first input light includes:
outputting, by a light source, second input light; and
generating, by a smart pixel array, the converted light based on the first input light and the second input light.

15. The method of claim 14, wherein the smart pixel array includes a smart pixel including a first semiconductor element and a second semiconductor element,
wherein the generating, by the smart pixel array, of the converted light based on the first input light and the second input light includes:
generating, by the first semiconductor element, an electrical signal based on the first input light; and
controlling, by the second semiconductor element, transmittance or reflectivity of the second input light based on the electrical signal.

16. The method of claim 15, wherein the AI optical system is based on a diffractive optical neural network.

17. The method of claim 16, wherein the AI optical system includes at least one diffractive optical element including a plurality of pixels.

18. The method of claim 17, wherein the at least one diffractive optical element adjusts intensity of light, and
wherein each of the plurality of pixels has different transmittance of light.

19. The method of claim 18, wherein the at least one diffractive optical element adjusts a phase of light, and
wherein each of the plurality of pixels has a different phase modulation value.

20. The method of claim 15, wherein the AI optical system is based on an optical convolutional artificial neural network using a 4F optical system.
